(19) United States
(12) Patent Application Publication
(10) Pub. No.: US 2026/0329217 A1
(43) Pub. Date: Oct. 22, 2026

(54) IMAGE FORMING APPARATUS, CONTROL METHOD, AND NON-TRANSITORY COMPUTER-READABLE RECORDING MEDIUM

(71) Applicant: Konica Minolta, Inc., Tokyo (JP)

(72) Inventors: Tomohiro MIKAMI, Tokyo (JP); Kazutoshi KOBAYASHI, Tokyo (JP); Takashi AKAZAWA, Tokyo (JP); Kei YUASA, Sagamihara-shi (JP); Kei OKAMURA, Yokohama-shi (JP)

(21) Appl. No.: 19/529,310

(22) Filed: Feb. 4, 2026

(30) Foreign Application Priority Data
Mar. 7, 2025 (JP) 2025-036761

(51) Int. Cl. G03G 15/00; G03G 15/01; G03G 15/08

(52) U.S. Cl. CPC G03G 15/556; G03G 15/0121; G03G 15/0126; G03G 15/0189; G03G 15/0849; G03G 15/0865; G03G 15/50; G03G 2215/0607

(57) ABSTRACT

An image forming apparatus includes: a developer storage portion that stores two-component developer containing toner and carrier; a supply portion supplying the two-component developer stored in the developer storage portion to a surface of an image bearing member; a discharge portion to discharge a surplus of the two-component developer from the developer storage portion; a carrier supply portion that replenishes the developer storage portion with carrier; and a controller calculating a variation amount of print coverage in a series of jobs on the basis of job information on the series of jobs subject to image formation and determining a supply amount of carrier to be replenished from the carrier supply portion on the basis of the variation amount.

### CROSS REFERENCE TO RELATED APPLICATIONS

The present application is based on Japanese Patent Application No. 2025-036761 filed on Mar. 7, 2025, the contents of which are incorporated herein by reference.

### BACKGROUND OF THE INVENTION

### Technical Field

The present invention relates to an image forming apparatus, a control method, and a non-transitory computer-readable recording medium. In particular, the present invention relates to a technique for forming an image using a two-component developer formed of toner and carrier.

### DESCRIPTION OF RELATED ART

An image forming apparatus that forms an image using two-component developer composed of toner and carrier includes a developing device. The developing device develops the electrostatic latent image with the toner by supplying a developer to the surface of the image bearing member on which the electrostatic latent image is formed. In this type of image forming apparatus, there is known an image forming apparatus adopting a trickle developing method in which unused toner and carrier are continuously or intermittently supplied to a developing device, and a developer deteriorated in the developing device is discharged from the developing device. Such a conventional technology is described in, for example, Japanese Unexamined Patent Publication No. JP2010-102256A (Patent Literature 1).

The image forming apparatus disclosed in Patent Literature 1 has a mechanism capable of separately replenishing the toner and the carrier. This image forming apparatus calculates print coverage of a print job and adds it to the print coverage so far to calculate the cumulative print coverage. The print coverage is synonymous with print coverage ratio. When the cumulative print coverage is equal to or more than a predetermined threshold value, the image forming apparatus replenishes the carrier. On the other hand, when the cumulative print coverage is less than the threshold value, the image forming apparatus does not supply the carrier.

However, in a case where the print coverage varies during execution of a job, the above-described conventional technology has a problem in that it is not possible to follow the variation, the charge amount of the toner greatly changes, and image defects such as image fog and toner scattering occur.

That is, the image forming apparatus disclosed in Patent Literature 1 replenishes carrier when the cumulative print coverage is equal to or more than a predetermined threshold value. However, when the cumulative print coverage does not become equal to or more than the threshold value, the carrier is not supplied. For that reason, in the case where the print coverage is largely lowered from the previous value, the carrier is not supplied in many cases. When the print coverage decreases, the consumption amount of the developer in the developing device decreases, and therefore, the deterioration of the developer progresses in the developing device. For this reason, when the image forming operation is continued in a state in which the print coverage is lowered, the charging amount of the toner is gradually lowered, so that an image defect generates.

### SUMMARY OF THE INVENTION

The present invention has been devised in order to solve the above-described conventional problems. That is, an object of the present invention is to provide an image forming apparatus capable of, even when a print coverage varies during execution of a job, following the variation in print coverage and maintaining a toner charge amount in a constant state. The present invention also provides a control method for such an image forming apparatus, and a non-transitory computer-readable recording medium.

In order to achieve the above objects, according to an aspect of the present invention, an image forming apparatus includes: a developer storage portion that stores two-component developer containing toner and carrier; a supply portion supplying the two-component developer stored in the developer storage portion to a surface of an image bearing member; a discharge portion to discharge a surplus of the two-component developer from the developer storage portion; a carrier supply portion that replenishes the developer storage portion with carrier; and a controller calculating a variation amount of print coverage in a series of jobs on the basis of job information on the series of jobs subject to image formation and determining a supply amount of carrier to be replenished from the carrier supply portion on the basis of the variation amount.

### BRIEF DESCRIPTION OF THE DRAWINGS

The advantages and features provided by one or more embodiments of the invention will become more fully understood from the detailed description given herein below and the appended drawings which are given by way of illustration only, and thus are not intended as a definition of the limits of the present invention.

FIG. 1 is a diagram illustrating an example of the configuration of an image forming apparatus;

FIG. 2 is an enlarged view illustrating an example of the configuration of the developing device;

FIG. 3 is a diagram illustrating an example of the configuration of the back side of the supply portion;

FIG. 4 is a flowchart illustrating an example of a processing procedure performed by a controller;

FIG. 5 is a diagram in which a series of jobs is divided into a plurality of sections and an average print coverage is calculated;

FIG. 6A is a diagram illustrating a carrier supply amount determined based on print coverages in a plurality of sections in comparative example 1;

FIG. 6B is a diagram illustrating a change in the average charge amount of the toner in a case where the carrier is supplied based on the carrier supply amount

FIG. 7A is a view showing the carrier supply amount determined on the basis of the print coverage of the plurality of sections in Comparison Example 2;

FIG. 7B is a diagram illustrating a change in the average charge amount of the toner in a case where the carrier is supplied based on the carrier supply amount;

FIG. 8 is a flowchart illustrating an example of a detailed processing procedure of the supply amount determination processing;

FIG. 9A is a diagram illustrating a carrier supply amount determined based on print coverages in a plurality of sections in an example;

FIG. 9B is a diagram illustrating a change in the average charge amount of the toner in a case where the carrier is supplied based on the carrier supply amount;

FIG. 10 is a flowchart illustrating a processing procedure of correcting a carrier supply amount during job execution;

FIG. 11 is a diagram illustrating another configuration example of the developing device;

FIG. 12A is a view showing the carrier supply amount determined on the basis of the print coverages in the plurality of sections in the example in which the first carriers and the second carriers are supplied; and

FIG. 12B is a view showing a change in the average charge amount of the toner when the carriers are supplied based on the carrier supply amount.

### DETAILED DESCRIPTION OF EMBODIMENTS

Hereinafter, one or more embodiments of the present invention will be described with reference to the drawings. However, the scope of the invention is not limited to the disclosed embodiments. Note that in the embodiments described below, common elements are denoted by the same reference signs, and redundant description thereof is omitted.

### IMAGE FORMING APPARATUS

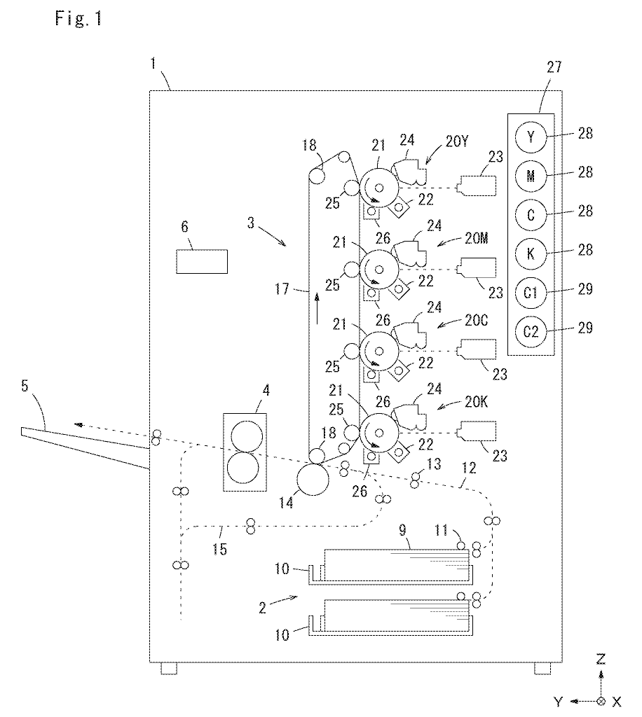

FIG. 1 illustrates an example of the configuration of an image forming apparatus 1 according to an embodiment of the present invention. Note that the XYZ three-dimensional coordinate system illustrated in FIG. 1 is a coordinate system in which the Z axis and the Y axis are defined as the horizontal direction and the Z axis is defined as the vertical direction, and is a coordinate system common to coordinate systems illustrated in other drawings.

The image forming apparatus 1 forms and outputs an image on a sheet-like recording medium 9 such as a printing sheet. The image forming apparatus 1 includes a sheet feed and conveyance section 2, an image forming section 3, a fixing section 4, a sheet ejection tray 5, and a controller 6. The sheet feed and conveyance section 2 feeds and conveys the recording medium 9. The image forming section 3 forms an image on the recording medium 9 conveyed by the sheet feed and conveyance section 2. The fixing section 4 fixes the image formed on the recording medium 9 to the recording medium 9. The sheet ejection tray 5 is a tray on which recording medium 9 output from the image forming apparatus 1 are stacked. The controller 6 is connected to the sheet feed and conveyance section 2, the image forming section 3, and the fixing section 4 and controls operation of them.

The sheet feed and conveyance section 2 includes a sheet feed cassette 10, a sheet feed roller 11, conveyance rollers 13, and secondary transfer rollers 14. The sheet feed cassette 10 is a container that stores the recording medium 9. The image forming apparatus 1 includes a plurality of sheet feed cassettes 10. The sheet feed and conveyance section 2 feeds the recording medium 9 one by one from sheet feed cassette 10 designated by a user among the plurality of sheet feed cassettes 10. That is, the sheet feed and conveyance section 2 feeds the recording medium 9 by driving the sheet feed roller 11 corresponding to the specified sheet feed cassette 10. The recording medium 9 fed by the sheet feed roller 11 is conveyed along a conveyance path 12. The conveyance path 12 is provided with a plurality of conveyance rollers 13. The sheet feed and conveyance section 2 conveys the recording medium 9 by rotationally driving the conveyance rollers 13.

The image forming section 3 transfers the image onto the recording medium 9 when the recording medium 9 conveyed by the sheet feed and conveyance section 2 passes through the position of the secondary transfer roller 14. The image forming section 3 generates a color image by superimposing toner images of four colors, for example, yellow (Y), magenta (M), cyan (C), and black (K), and transfers the color image to the recording medium 9. The image forming section 3 includes a plurality of image forming units 20Y, 20M, 20C, and 20K and an intermediate transfer belt 17.

The image forming units 20Y, 20M, 20C, and 20K generate toner images in respective colors of Y, M, C, and K, and primarily transfer the toner images onto the intermediate transfer belt 17. The intermediate transfer belt 17 is constituted by an endless belt, and is circulated so as to pass through the installation positions of the plurality of image forming units 20Y, 20M, 20C, and 20K.

The image forming units 20Y, 20M, 20C, and 20K have the same configuration. That is, each of the image forming units 20Y, 20M, 20C, and 20K includes an image bearing member 21 formed with a photosensitive drum or the like. The image bearing member 21 has a photosensitive layer on its surface, and is rotationally driven in a predetermined direction. Around the image bearing member 21, a charging device 22, an exposure device 23, a developing device 24, and a cleaner 26 are provided. The charging device 22 charges the surface of the image bearing member 21 to a predetermined charge. The exposure device 23 exposes the electrically charged surface of the image bearing member 21 to light to form an electrostatic latent image onto the surface of the image bearing member 21. The developing device 24 applies a two-component developer composed of a toner and a carrier to the surface of the image bearing member 21 and develops the electrostatic latent image with the toner. Thus, a toner image is formed on the surface of the image bearing member 21.

Inside the intermediate transfer belt 17, a primary transfer roller 25 is provided at a position facing the image bearing member 21 of each of the image forming units 20Y, 20M, 20C, and 20K. The primary transfer roller 25 presses the intermediate transfer belt 17 against the surface of the image bearing member 21, and by application of a predetermined voltage, primarily transfers the toner image formed on the surface of the image bearing member 21 onto the intermediate transfer belt 17. The toner remaining on the surface of the image bearing member 21 without being transferred to the intermediate transfer belt 17 is collected by the cleaner 26.

The image forming units 20Y, 20M, 20C, and 20K sequentially perform primary transfer of the toner images in the respective colors of Y, M, C, and K onto the intermediate transfer belt 17. As the result, a color image is formed on the surface of the intermediate transfer belt 17. The intermediate transfer belt 17 secondarily transfers the color image at the position of the secondary transfer roller 14 onto the recording medium 9 conveyed by the sheet feed and conveyance section 2.

After the image is transferred onto the recording medium 9 by the secondary transfer roller 14, the recording medium 9 is conveyed to the fixing section 4. The fixing section 4 includes a heating roller and a pressure roller. The fixing section 4 fixes the image to the recording medium 9 by performing a heating process and a pressurizing process on the recording medium 9 to which the image is transferred.

A reverse path 16 is provided in the conveyance path 12 on the downstream side of the fixing section 4. The reverse path 16 is a conveyance path that reverses the front and back of the recording medium 9 and guides the recording medium 9 to the secondary transfer roller 14 again. In a case where double-sided printing is set in the print job, after an image is formed on a first surface of the recording medium 9, the sheet feed and conveyance section 2 guides the recording medium 9 to the reverse path 16. The image forming section 3 forms an image on a first surface of the recording medium 9, and then forms an image on a second surface of the recording medium 9 conveyed again. Next, after images are formed on both front and back sides, the recording medium 9 is ejected to the sheet ejection tray 5. Note that when double-sided printing is not set, the recording medium 9 is ejected to the sheet ejection tray 5 without being conveyed to the reverse path 16.

The image forming apparatus 1 further includes a bottle holding portion 27 that holds toner bottles 28 of Y, M, C, and K colors. The image forming apparatus 1 supplies toner to the developing device 24 for the respective colors by driving the toner bottle 28 mounted in the bottle holding portion 27. Further, the bottle holding portion 27 is mounted with and holds two carrier bottles 29 containing carriers different in charging performance. The image forming apparatus 1 supplies the carrier to the developing device 24 of each color by individually driving the two carrier bottles 29.

In Comparative Example 1 to be described later, the toner bottle 28 supplies a two-component developer containing a toner and a carrier to the developing device 24. In addition, in the control of Comparative Example 2 and the present embodiment which will be described later, the toner bottle 28 supplies only the toner to the developing device 24, and the carrier bottle 29 supplies only the carrier.

### DEVELOPING DEVICE

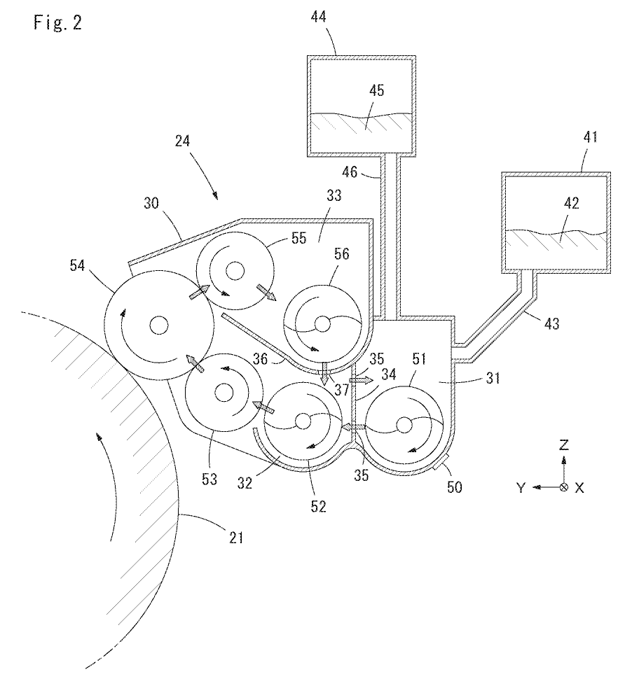

FIG. 2 is an enlarged view illustrating a detailed configuration example of the developing device 24. The developing device 24 includes a developer storage portion 30 that stores a two-component developer. The developer storage portion 30 includes a stirring portion 31, a supply portion 32, and a collection portion 33 therein. The toner storage portion 41 and a carrier supplying portion 44 are connected to the stirring portion 31.

The toner storage portion 41 stores the toner 42 supplied from the toner bottle 28. The toner storage portion 41 is connected to the stirring portion 31 via a supply path 43. The supply path 43 is provided with a valve and a shutter (not illustrated). The controller 6 opens and closes the valve and the shutter to replenish the stirring portion 31 with the toner 42 from the toner storage portion 41. For example, the controller 6 can arbitrarily adjust the supply amount and supply timing of the toner 42 by controlling the opening and closing operations of the valve and the shutter. Alternatively, instead of the valve and the shutter, a configuration may be adopted in which a screw for supply is provided in the toner storage portion 41 and the controller 6 rotates the screw to control the supply amount and the supply timing of the toner 42.

In Comparative Example 1 described later, a two-component developer containing a toner and a carrier is accommodated in the toner storage portion 41. Therefore, in Comparative Example 1 described later, when the toner is supplied from the toner storage portion 41 to the stirring portion 31, the carrier is supplied at the same time.

The carrier supplying portion 44 stores the carrier 45, and singly replenishes the stirring portion 31 with the carrier 45. The carrier supplying portion 44 is connected to the stirring portion 31 via a supply path 46. The supply path 46 is provided with a valve and a shutter (not illustrated). The controller 6 drives the opening and closing of the valve and the shutter to replenish the stirring portion 31 with the carrier 45 from the carrier supplying portion 44. For example, the controller 6 can arbitrarily adjust the supply amount and supply timing of the carrier 45 by controlling the opening and closing operation of the valve and the shutter. Further, in place of the valve and the shutter, a constitution in which a supplying screw is provided in the carrier supplying portion 44 and the controller 6 controls the supply amount and the supply timing of the carrier 45 by rotating the screw may also be employed.

The stirring portion 31 is provided with a stirring screw 51. The controller 6 drives the stirring screw 51 to stir the two-component developer contained in the stirring portion 31. Furthermore, a toner concentration sensor 50 is attached to an outer wall of the stirring portion 31.

The toner concentration sensor 50 detects a toner concentration in the stirring portion 31. When a print job is executed in the image forming apparatus 1, toner is consumed. When the toner is consumed, the toner concentration in the stirring portion 31 varies. The toner concentration sensor 50 detects a change in the toner concentration. The controller 6 supplies the toner 42 or the carrier 45 to the stirring portion 31 based on the detection result of the toner concentration sensor 50.

The supply portion 32 is provided adjacent to the stirring portion 31. A partition wall 34 is provided between the supply portion 32 and the stirring portion 31. In the partition wall 34, an opening 35 for allowing the developer to flow therethrough is provided.

The supply portion 32 is provided with a supply screw 52. A supply roller 53 is provided at a position adjacent to the supply screw 52. Furthermore, a developing roller 54 is provided so as to be close to an outer peripheral surface of the supply roller 53. The developing roller 54 is in proximity to the surface of the image bearing member 21 and applies developer composed of toner and carrier to the surface of the image bearing member 21 to develop the electrostatic latent image with toner.

The collection portion 33 is provided above the supply portion 32. The collection portion 33 is provided with a collecting roller 55 and a collecting screw 56. The collecting roller 55 comes close to the surface of the developing roller 54 and collects the developer remaining on the surface of the developing roller 54. A partition wall 36 is provided between the collection portion 33 and the supply portion 32. The partition wall 36 is provided with an opening 37 for circulating the developer.

As the stirring screw 51 in the stirring portion 31 rotates in a predetermined direction, the developer moves in the -X direction illustrated in FIG. 2 while being stirred in the stirring portion 31. In the process of the movement, the developer is fed from the stirring portion 31 to the supply portion 32 via the opening 35.

When the supply screw 52 rotates in a predetermined direction in the supply portion 32, the developer moves in the +X direction while being stirred. In the process of the movement, the developer is supplied to the supply roller 53. Some of the developer moving in the supply portion 32 is returned to the stirring portion 31 via the opening 35.

The developer supplied to the supply roller 53 is supplied to the developing roller 54. The developer supplied to the developing roller 54 is supplied to the surface of the image bearing member 21 with rotation of the developing roller 54, to develop the electrostatic latent image formed on the image bearing member 21. The developer that is not used for developing the electrostatic latent image and remains on the surface of the developing roller 54 is collected by the collecting roller 55 into an inner side of the collection portion 33. The collecting screw 56 rotates in a predetermined direction to convey the developer collected by the collecting roller 55 in the +X direction while stirring the developer. Next, the collected developer is returned to the supply portion 32 again via an opening 37 provided on the back side of the collection portion 33. Some of the developer returned to the supply portion 32 returns to the stirring portion 31 via the opening 35. As described above, the developing device 24 is configured to circulate the developer in the developer storage portion 30.

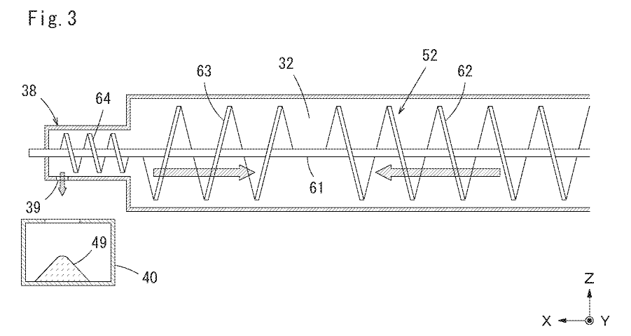

FIG. 3 is a view illustrating an example of a configuration of the back side (+X direction side) of the supply portion 32. As shown in FIG. 3, a discharge portion 38 for discharging is provided at a back end portion of the supply portion 32. The discharge portion 38 is provided with a discharge port 39 for discharging an excess of the developer from the developer storage portion 30.

The supply screw 52 provided in the supply portion 32 is also provided inside the discharge portion 38 thereof. The supply screw 52 includes a first screw 62, a second screw 63, and a third screw 64 along the axial direction of the rotation shaft 61. The first screw 62 is a forward winding screw, and conveys the developer in the left direction (+X direction) of the supply portion 32 by the supply screw 52 rotating in a predetermined direction. The second screw 63 is a reversely wound screw, and is provided between the first screw 62 and the third screw 64. The second screw 63 conveys the developer in the right direction (-X direction) of the supply portion 32 by the supply screw 52 rotating in a predetermined direction. That is, the second screw 63 pushes back the developer conveyed toward the discharge portion 38 of the supply portion 32 by the first screw 62 in the opposite direction. The third screw 64 is disposed inside the discharge portion 38. The third screw 64 is a forward winding screw and conveys the developer toward the discharge port 39 provided on the back side of the discharge portion 38 by the rotation of the supply screw 52 in a predetermined direction.

Therefore, when the supply screw 52 rotates in the supply portion 32, the developer that has exceeded the second screw 63 enters the discharge portion 38. This phenomenon occurs when the developer accommodated in the developer storage portion 30 exceeds a predetermined amount. Then, the developer having entered the discharge portion 38 is conveyed to the discharge port 39 by the third screw 64, and is discharged from the discharge port 39 to the outside of the developer storage portion 30. A collection container 40 is provided below the discharge port 39. The developer 49 discharged from the developer storage portion 30 is accumulated and collected inside the collection container 40.

As described above, the developing device 24 employs a trickle developing method. That is, the developing device 24 can appropriately replenish the developer storage portion 30 with the developer, and can also replenish the developer storage portion 30 with the carrier alone. Furthermore, the developing device 24 is capable of replacing deteriorated carrier with new carrier by collecting developer that has become excessive through replenishment.

### OPERATION BY CONTROLLER

Next, a control operation by the controller 6 will be described. The controller 6 includes a hardware processor and a storage section (not shown). The hardware processor executes a program stored in the storage section. Thus, the controller 6 controls the operation of each section of the image forming apparatus 1. In particular, the controller 6 according to the present exemplary embodiment controls the supply operation of the carrier to the developing device 24, thereby suppressing a change in the toner charge amount and performing control so that high-quality image formation can be stably performed. Hereinafter, the supply operation of the carrier by the controller 6 will be described in detail.

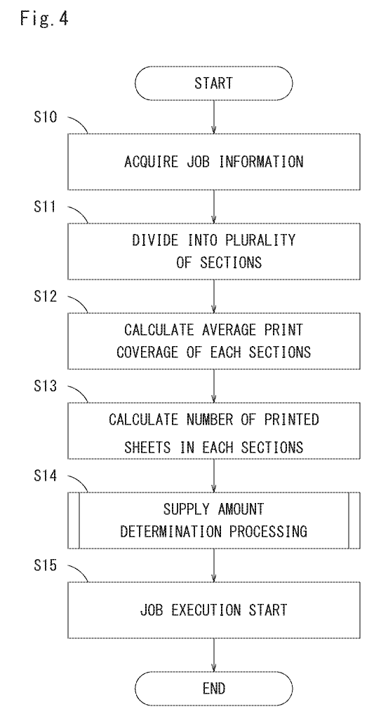

FIG. 4 is a flowchart illustrating an example of a processing procedure performed by the controller 6. This process is performed by the hardware processor of the controller 6 executing a program. The controller 6 acquires job information on a series of jobs to be printed in the image forming apparatus 1 (step S10). The job information is information on a print job to be executed in the image forming apparatus 1. The job information in the present embodiment is exemplified by the case of information regarding a job of continuously performing printing and outputting of 50000 sheets. Such a series of jobs may be configured by one print job, or may be configured by combining a plurality of print jobs.

Upon acquiring the job information, the controller 6 divides a series of jobs into a plurality of sections. For example, the controller 6 acquires print coverage of each image included in the job information. The print coverage is synonymous with print coverage ratio. At this time, if the print coverage X of each image is, for example, 7.5% < X≤12.5%, the print coverage X is acquired as 10%. That is, the controller 6 acquires the print coverage of each image as a value divided in units of 5%.

Upon acquiring the print coverage of each image included in the job information, the controller 6 generates a plurality of sections by dividing a series of jobs by the unit of the predetermined number of printed sheets. For example, the controller 6 divides the job in units of 500 sheets. Thus, the job of printing and outputting 50000 sheets is divided into 100 sections. When dividing a series of jobs into a plurality of sections, the controller 6 may divide the series of jobs such that the number of printed sheets in each section is at least equal to or greater than a predetermined number.

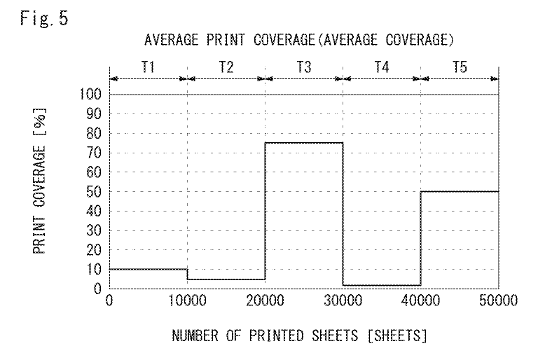

Thereafter, the controller 6 calculates an average print coverage of each section. In a case where the difference between the average print coverage calculated from a plurality of continuous sections is within a predetermined range, the controller 6 integrates the plurality of sections into one section. As a result, for example, as illustrated in FIG. 5, a series of jobs defined by the job information is divided into five sections T1 to T5.

Note that FIG. 5 illustrates an example in which a job of printing out 50000 sheets is equally divided into five sections T1 to T5 for the sake of simplicity. However, in actual, equally divided sections are not necessarily obtained. Further, a series of jobs may be divided into five or more sections. For example, in a case where a process of integrating a plurality of continuous sections into one section is not performed, a process to be described below may be performed in a state where a job for printing and outputting 50000 sheets is divided into 100 sections.

Upon dividing a series of jobs into a plurality of sections, the controller 6 recalculates the average print coverage of each section (step S12). Furthermore, the controller 6 calculates the number of printed sheets in each section (step S13). As a result, as shown in FIG. 5, the average print coverage and the number of printed sheets in each of the five sections T1 to T5 are calculated.

When calculating the average print coverage and the number of printed sheets in the plurality of sections T1 to T5 as shown in FIG. 5, the controller 6 executes a supply amount determination processing (step S14). In this supply amount determination processing, the amount of the carrier supply during the execution of the job is determined. This supply amount determination processing is performed before execution of a job is started in the image forming apparatus 1. Details of the replenishment amount determination processing in the present embodiment will be described later.

Upon determining the supply amount of carriers during the execution of the job, the controller 6 starts the execution of the job (step S15). Next, during execution of the job, the controller 6 replenishes the developer storage portion 30 with the carrier based on the supply amount of the carrier determined in advance in the supply amount determination processing in step S14.

### SUPPLY AMOUNT DETERMINATION PROCESSING

### Comparative Example 1

Here, before describing the supply amount determination processing in the present embodiment, an example in which the two-component developer containing the toner and the carrier is replenished from the toner storage portion 41 to the developer storage portion 30 will be described as Comparative Example 1. Therefore, in Comparative Example 1, the above-described carrier supply from the carrier supplying portion 44 to the developer storage portion 30 is not performed.

In a case where the developer is supplied only from the toner storage portion 41, the supply amount of the carriers is determined based on the print coverage of each of the sections T1 to T5 illustrated in FIG. 5. That is, the consumption amount of toner in the developer storage portion 30 in this case changes similarly to the change in the print coverage illustrated in FIG. 5. Therefore, it is necessary to supply the toner in accordance with the consumption amount of the toner, and the supply amount of the carrier is determined so as to be proportional to the supply amount of the toner.

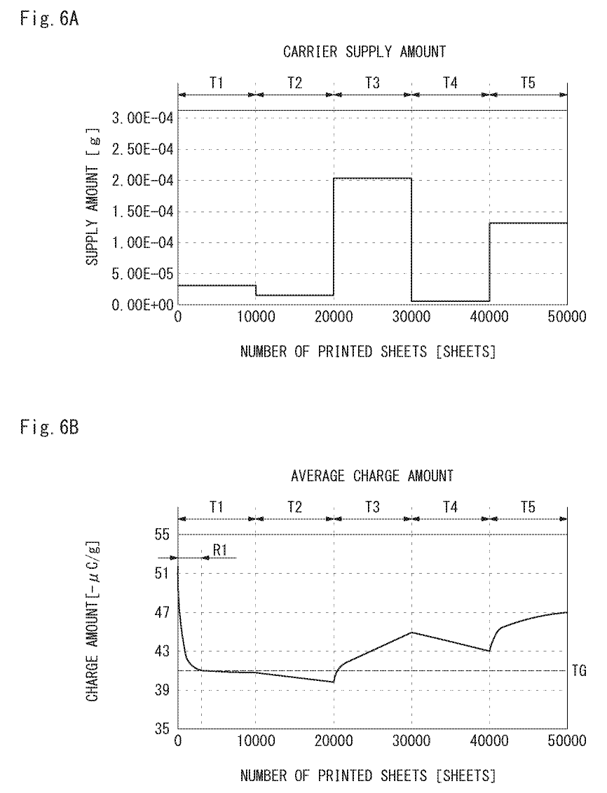

FIG. 6A is a diagram illustrating a supply amount of carriers determined based on the print coverage in each of the sections T1 to T5 illustrated in FIG. 5 in Comparative Example 1. In the case where the developer containing the toners and the carriers is supplied only from the toner storage portion 41, the supply amount of the carriers is determined so as to change in conjunction with the change in the print coverage as shown in FIG. 6A.

FIG. 6B illustrates change in average charge amount of toner in a case where the controller 6 replenishes carriers based on the supply amount of carriers illustrated in FIG. 6A after execution of a job is started. FIG. 6B illustrates a target charge amount TG with which high-quality image formation can be performed. Before start of execution of a job, the developer in the developer storage portion 30 is accumulated in a stationary state. Therefore, in the predetermined period R1 immediately after the start of the execution of the job, the charge amount of the toner is relatively high. After start of execution of a job, as the developer stirring operation is performed in the developing device 24, the charge amount of toner decreases and approaches a target charge amount TG. If the stirring operation is started in the developing device 24 prior to the start of the execution of the job, the charge amount of the toner immediately after the start of the execution of the job can be brought close to the target charge amount TG in advance.

Since the print coverage is relatively low in the section T1, the amount of carrier supply is small. Therefore, even when printing in the section T1 progresses, the replacement of the carriers does not progress in the developer storage portion 30, the carriers gradually deteriorate, and the chargeability decreases. Accordingly, the charge amount of the toner in the section T1 gradually decreases.

The section T2 has a lower print coverage than the section T1. Therefore, the replenishment amount of carriers in the section T2 is further smaller than that in the section T1, and the degradation of carriers progresses. Along with this, the charge amount of toner in the section T2 further decreases than in the section T1.

In the section T3, the print coverage is as high as 75%, so that the amount of carrier supply is large. In particular, immediately after switching from the section T2 to the section T3, a large amount of carriers having high chargeability is supplied to the developer storage portion 30 in accordance with the amount of toner consumption. Therefore, the charge amount of the toner rapidly increases immediately after the section T2 is switched to the section T3. Further, even during the progress of the print output in the section T3, the supply operation of a large amount of carrier is continued. As a result, the toner charge amount gradually increases as the printing output in section T3 progresses.

In the section T4, the print coverage decreases again. Therefore, the supply amount of carrier in the section T4 becomes small. Then, even when printing output in section T4 progresses, the replacement of the carrier does not progress in the developer storage portion 30 and the carrier gradually deteriorates. Accordingly, the charge amount of the toner in the section T4 gradually decreases.

In the section T5, since the print coverage is high, the supply amount of carriers is large. In particular, immediately after switching from the section T4 to the section T5, a large amount of carrier having high chargeability is supplied to the developer storage portion 30 in accordance with the amount of toner consumed. Therefore, the charge amount of the toner rapidly increases immediately after the section T4 is switched to the section T5. Further, even during the progress of the print output in the section T5, the supply operation of a large amount of carrier is continued. Therefore, the charge amount of the toner gradually increases as printing output in section T5 progresses.

As illustrated in FIG. 6B, when the charge amount changes during execution of a job, image defects such as image fog and toner scatter are highly likely to occur. Therefore, in Comparative Example 1, in the case where the print coverage varies during the execution of the job, the charge amount of the toner cannot be maintained in a constant state, so that a high-quality image cannot be formed.

### COMPARATIVE EXAMPLE 2

Next, as Comparative Example 2, an example in which the carriers are singly supplied from the carrier supplying portion 44 based on the print coverage of each of the sections T1 to T5 will be described. In Comparative Example 2, only the toner 42 is replenished from the toner storage portion 41 to the developer storage portion 30, and only the carrier is replenished from the carrier supplying portion 44. Therefore, in comparison with Comparative Example 1, Comparative Example 2 can suppress the fluctuation in the toner charge amount more than Comparative Example 1. Note that the carrier having higher charging performance is supplied from a carrier bottle 29 to the carrier supplying portion 44.

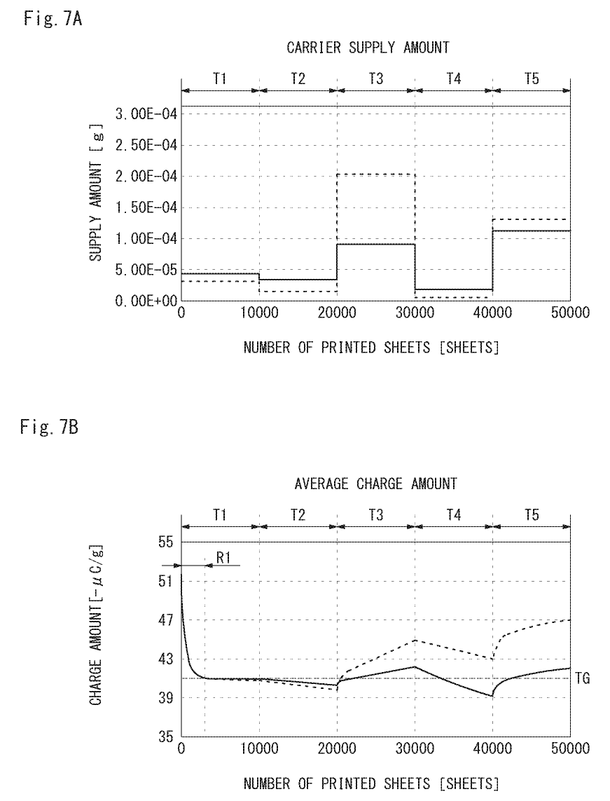

FIG. 7A is a diagram illustrating the supply amount of carriers determined based on the print coverage of each of the sections T1 to T5 illustrated in FIG. 5 in Comparative Example 2. In FIG. 7A, the solid line indicates the amount of carriers supplied in Comparative Example 2, and the broken line indicates the amount of carriers supplied in Comparative Example 1. As illustrated in FIG. 7A, when the supply amount of carriers in each of the sections T1 to T5 is determined on the basis of only the print coverage, the supply amount of carriers in each of the sections T1 to T5 becomes constant. This point is the same as Comparative Example 1. Provided that Comparative Example 2 is different from Comparative Example 1 in the following points.

First, in Comparative Example 1, the amount of carrier supply in the sections T1, T2, and T4 was small, so that the toner charge amount gradually decreased in the process of progress of printing out in the sections T1, T2, and T4. Therefore, in Comparative Example 2, the amount of carrier supply in the sections T1, T2, and T4 is larger than that in Comparative Example 1.

Second, in Comparative Example 1, since the amount of carrier supply in the sections T3 and T5 was large, the toner charge amount gradually increased in the process of the progress of printing in the sections T3 and T5. Therefore, in Comparative Example 2, the amount of carrier supply in the sections T3 and T5 is smaller than that in Comparative Example 1.

FIG. 7B illustrates change in average charge amount of toner in a case where the controller 6 replenishes carriers based on the amount of carrier supply illustrated in FIG. 7A after execution of a job is started. Note that in FIG. 7B, the solid line indicates the charge amount of Comparative Example 2, and the broken line indicates the charge amount of Comparative Example 1. In FIG. 7B, the target charge amount TG is shown as in Comparative Example 1.

As illustrated in FIG. 7B, the charge amount of toner rapidly decreases for a predetermined period R1 immediately after the start of execution of a job. However, as described above, the rapid decrease in the charge amount during the predetermined period R1 can be eliminated by starting the stirring operation in the developing device 24 prior to the start of the execution of the job.

In the sections T1, T2, and T4, more carriers are supplied in Comparative Example 2 than in Comparative Example 1. Therefore, in the sections T1, T2, and T4, Comparative Example 2 suppresses a reduction in the amount of charge more than Comparative Example 1. In addition, in the sections T3 and T5, more carriers are supplied in Comparative Example 2 than in Comparative Example 1. Therefore, in the sections T3 and T5, Comparative Example 2 suppresses the increase in the charge amount more than Comparative Example 1. Therefore, in comparison with Comparative Example 1, in Comparative Example 2, the fluctuation of the toner charge amount during the execution of the job is suppressed.

However, even in the case of Comparative Example 2, when there is a variation in the print coverage at the time of transition from the previous section to the subsequent next section, the change in the toner charge amount at the time of section switching becomes large. Therefore, even in the case of Comparative Example 2, the fluctuation of the toner charge amount is still large, and a high-quality image cannot be stably formed particularly at the time of switching between sections. For example, in order to stably form a high-quality image at the time of section switching, it is preferable to suppress the change in the charge amount to about ± 1 [-μ C/g]. However, the change in the charge amount in Comparative Example 2 is larger than that in Comparative Example 1.

### SUPPLY AMOUNT DETERMINATION PROCESSING BY CONTROLLER 6

Next, the supply amount determination processing by the controller 6 in the present embodiment will be described. The controller 6 of the present embodiment performs control so as to suppress variation in the toner charge amount due to variation in the print coverage at the time of transition from the preceding section to the subsequent next section. Note that in the present embodiment, as in Comparative Example 2, only the toner 42 is replenished from the toner storage portion 41 to the developer storage portion 30, and only the carrier is replenished from the carrier supplying portion 44. Note that the carrier having higher charging performance is supplied from a carrier bottle 29 to the carrier supplying portion 44.

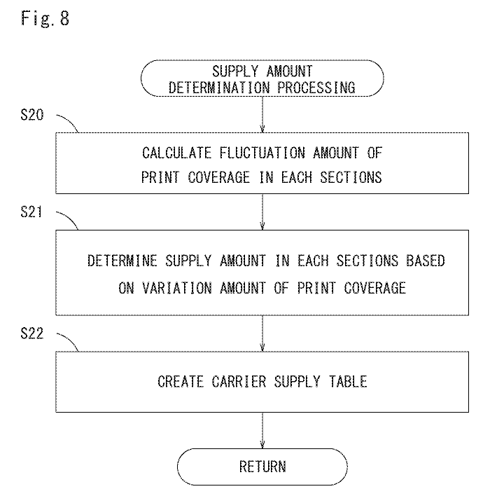

FIG. 8 is a flowchart illustrating an example of a detailed processing procedure of the supply amount determination processing (step S14) performed by the controller 6. When starting the supply amount determination processing, the controller 6 calculates the variation amount of the print coverage in each section (step S20). That is, the controller 6 calculates the variation amount of the print coverage at each of the time of transition from the section T1 to the section T2, the time of transition from the section T2 to the section T3, the time of transition from the section T3 to the section T4, and the time of transition from the section T4 to the section T5.

Next, the controller 6 determines the supply amount of the carriers in each section based on the variation amount of the print coverage in each section (step S21). For example, the controller 6 determines whether the average print coverage in the next section subsequent to the previous section is smaller or larger than the average print coverage in the previous section based on the variation amount of the print coverage in each section.

In a case where the average print coverage in the next section following the previous section is smaller than the average print coverage in the previous section, the controller 6 determines to increase the supply amount of the carrier immediately after the transition to the next section to be larger than the supply amount of the carrier in the previous section. Then, the controller 6 determines to gradually reduce the amount of carrier to be supplied as the number of printed sheets in the next section increases immediately after the transition to the next section.

In contrast, if the average print coverage in the next section subsequent to the previous section is higher than the average print coverage in the previous section, controller 6 determines to hold the amount of carrier supplied in the next section at a constant value corresponding to the average print coverage in the next section.

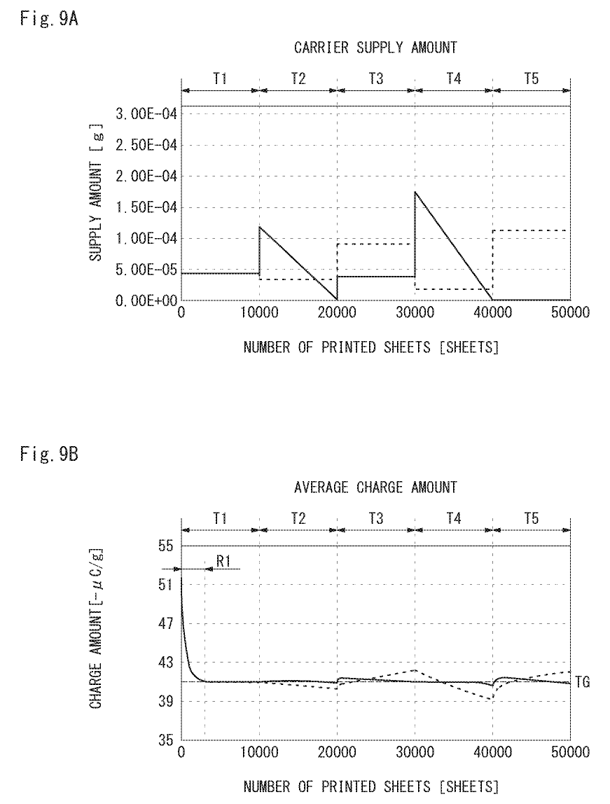

FIG. 9A is a diagram illustrating a supply amount of carriers determined in supply amount determination processing according to the present embodiment. In FIG. 9A, the solid line indicates the carrier supply amount in this embodiment, and the broken line indicates the carrier supply amount in Comparative Example 2. As illustrated in FIG. 9A, the supplied amount of carriers in the section T1 located at the head of the job is the same as that in Comparative Example 2.

The average print coverage of the section T2 is smaller than the average print coverage of the section T1. Therefore, the controller 6 increases the amount of carrier supply immediately after transition to the section T2 to a greater extent than the amount of supply in the section T1. The amount of carrier supply immediately after transitioning to the section T2 is determined, for example, based on the difference between the average print coverage in the section T1 and the average print coverage in the section T2. As the printing output in section T2 progresses, the carrier supply amount is gradually reduced. At this time, the controller 6 calculates a coefficient for decreasing the carrier supply amount depending on the number of printed sheets in the section T2 and determines so as to decrease the carrier supply amount based on the calculated coefficient.

The average print coverage of the section T3 is larger than the average print coverage of the section T2. For this reason, the controller 6 holds the carrier supply amount in the section T3 at a constant value corresponding to the carrier supply amount in the section T2.

The average print coverage in the section T4 is lower than the average print coverage in the section T3. Therefore, the controller 6 increases the amount of carrier supply immediately after transition to section T4 to a greater extent than the amount of supply in section T3. The carrier supply amount immediately after transitioning to section T4 is determined based on, for example, the difference between the average print coverage in section T3 and the average print coverage in section T4. As the printing output in section T4 progresses, the carrier supply amount is gradually reduced. At this time, the controller 6 calculates a coefficient for decreasing the carrier supply amount depending on the number of printed sheets in the section T4 and determines so as to decrease the carrier supply amount based on the calculated coefficient.

The average print coverage of the section T5 is larger than the average print coverage of the section T4. Therefore, the controller 6 holds the carrier supply amount in the section T5 at a constant value corresponding to the carrier supply amount in the section T4. In the example of FIG. 9A, since the total amount of the carrier supply amount in the section T4 is large, the carrier deterioration does not progress in the section T4. Therefore, the controller 6 reduces the amount of carrier supply in section T5 to suppress an increase in the amount of charge due to excessive carrier supply.

After determining the carrier supply amount in each section as described above, the controller 6 creates a carrier supply table and temporarily stores the carrier supply table in the storage section or the like (step S22). The carrier supply table is read by the controller 6 at the start of execution of a job, and is used for a carrier supply operation during execution of the job.

FIG. 9B illustrates change in average charge amount of toner in a case where the controller 6 replenishes carriers based on the supply amounts of carriers illustrated in FIG. 9A after execution of a job is started. Note that in FIG. 9B, the solid line indicates the charge amount in the present embodiment, and the broken line indicates the charge amount in Comparative Example 2. In addition, the target charge amount TG similar to those of Comparative Examples 1and 2 are illustrated in FIG. 9B.

As illustrated in FIG. 9B, the charge amount of toner rapidly decreases for a predetermined period R1 immediately after the start of execution of a job. However, as described above, the rapid decrease in the charge amount during the predetermined period R1 can be eliminated by starting the stirring operation in the developing device 24 prior to the start of the execution of the job.

The controller 6 can promote the replacement of the carrier in the developer storage portion 30 since the supply amount of the carrier is largely increased when the print coverage becomes small. For that reason, the deterioration of the carrier caused by the change in the low print coverage is suppressed, so that the toner charge amount is prevented from largely changing.

In addition, the amount of toner consumption is small in a section where printing output at a low print coverage continues. At this time, if the supply of a large amount of carrier alone is continued, the charge amount tends to increase gradually. In order to prevent this, the controller 6 replenishes a large amount of carrier at a timing when the print coverage becomes small, and thereafter gradually decreases the amount of carrier to be replenished. As a result, as illustrated in FIG. 9B, the amount of charge can be held substantially constant in the segment in which printing output at a low print coverage continues.

Furthermore, when the print coverage increases, the controller 6 holds the charge amount of the toner constant by holding the carrier supply amount constant.

Therefore, the image forming apparatus 1 according to the present embodiment can keep the change in the toner charge amount in each of the sections T1 to T5, except for the predetermined period R1, within a range of ± 1 [-μ C/g] relative to the target charge amount TG. That is, the image forming apparatus 1 of the present embodiment determines the carrier supply amount based on the amount of variation in the print coverage, so that it is possible to suppress the occurrence of image defects such as image fog and toner scattering. As a result, the image forming apparatus 1 can form a high-quality image on the recording medium 9 even when the print coverage varies during execution of a series of jobs.

### CORRECTION OF CARRIER SUPPLY AMOUNT DURING EXECUTION OF JOB

The controller 6 controls the carrier supply operation during the execution of the series of jobs based on the carrier supply table created before the start of the execution of the series of jobs. At this time, the controller 6 may acquire an indicator value indicating the actual state of the two-component developer and correct the carrier supply amount described in the carrier supply table based on the indicator value. Examples of the indicator values indicating the actual state of the two-component developer include the toner charge amount, the toner transfer amount, the bulk density of the two-component developer, and the driving load of the supply portion 32.

The actual toner charge amount can be acquired by forming a patch image for charge amount detection on the image bearing member 21 between images during execution of a job and measuring a development current when the patch image is developed. That is, when the toner charge amount changes, the developing current also changes, and therefore, by measuring the developing current, the actual toner charge amount can be detected. Upon detecting the actual toner charge amount, the controller 6 calculates a deviation amount from the toner charge amount predicted at the time of creating the carrier correction table. The controller 6 discriminates whether or not the correction of the carrier supply amount is necessary on the basis of the deviation amount.

The actual toner transfer amount can be obtained by transferring measurement images onto the image bearing member 21 at two or more levels of development potential between images during execution of a job and measuring the transfer density of the measurement image transferred onto the image bearing member 21 at each development potential. In this case, it is sufficient that a sensor for measuring the density is provided around the image bearing member 21. For example, the controller 6 calculates the slope of the transfer density measured at each development potential and determines, from the amount of deviation between the calculated slope and a reference slope, whether the amount of carrier supply needs to be corrected.

The actual bulk density of the developer can be acquired by, for example, measuring an angle of repose of the developer 49 accumulated in the collection container 40. The controller 6 calculates a deviation amount between the measured angle of repose and a predetermined angle. The controller 6 discriminates whether or not the correction of the carrier supply amount is necessary on the basis of the deviation amount. For example, when the measured angle of repose is smaller than a predetermined angle, the controller 6 determines that the bulk density of the developer is small and determines the correction amount so as to increase the carrier supply amount.

The driving load of the supply portion 32 is, for example, the torque of the motor that drives the supply screw 52. For example, in the case where the torque of the motor rapidly increases, the controller 6 discriminates that the carrier supply amount is large and determines the correction amount so as to reduce the carrier supply amount.

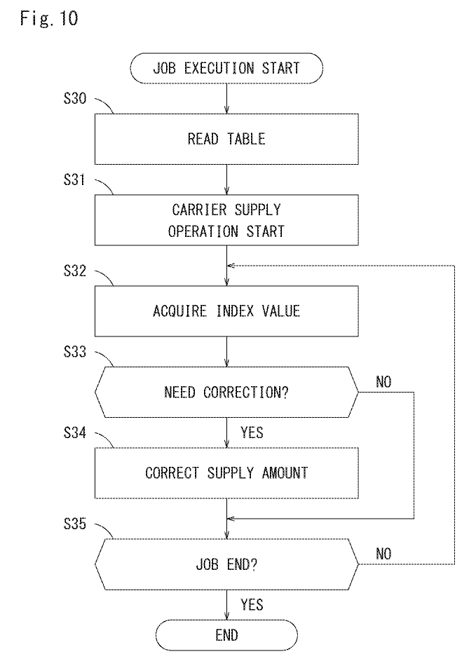

FIG. 10 is a flowchart illustrating a processing procedure of correcting a carrier supply amount during execution of a job. When the execution of the job is started, the controller 6 reads the carrier supply table (step S30) and starts the carrier reinforcing operation based on the carrier supply table (step S31).

Thereafter, the controller 6 acquires an indicator value indicating an actual state of the two-component developer at a predetermined timing during execution of the job (step S32). That is, as described above, the controller 6 acquires the indicator value including at least one of the toner charge amount, the toner transfer amount, the bulk density of the developer, and the driving load of the supply portion. At this time, the controller 6 functions as an acquisition section. Next, the controller 6 determines, based on the acquired indicator value, whether the carrier supply amount described in the carrier supply table needs to be corrected (step S33).

If correction is necessary (YES in step S33), the controller 6 determines the amount of correction based on the acquired indicator value and corrects the amount of supply of carriers described in the carrier supply table (step S34). In this case, the controller 6 controls the subsequent carrier supply operation on the basis of the corrected carrier supply amount. On the other hand, when the correction is not necessary (NO in step S33), the controller 6 does not correct the carrier supply amount.

Thereafter, the controller 6 repeatedly executes the processing of steps S32 to S34 until the execution of the series of jobs ends (step S35). Then, as the execution of the job ends, the processing by the controller 6 also ends.

As described above, the controller 6 appropriately corrects, during the execution of a job, the carrier supply amount determined before the start of the execution of the job, so that carrier supply in accordance with the actual state of the two-component developer can be performed. Therefore, there is an advantage that the image forming apparatus 1 can form a higher-quality image.

### ANOTHER CONFIGURATION EXAMPLE OF THE DEVELOPING DEVICE 24

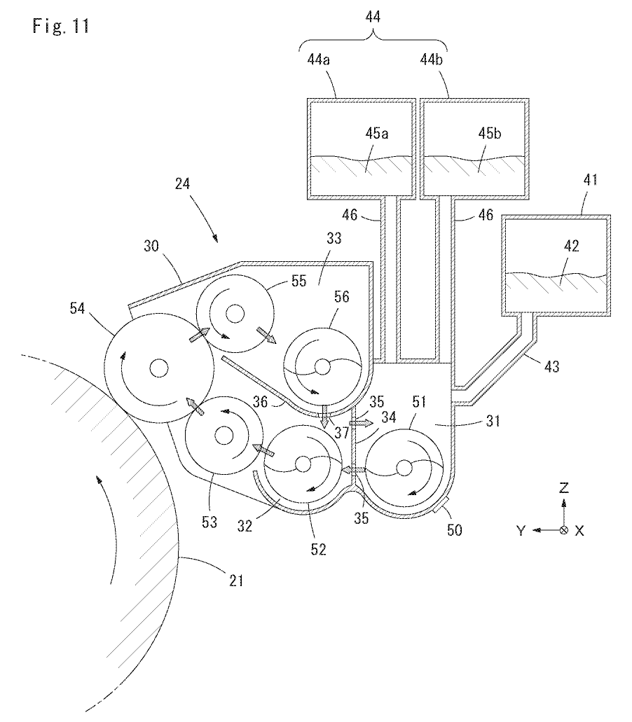

Next, another configuration example of the developing device 24 will be described. FIG. 11 is a diagram illustrating another configuration example of the developing device 24. The developing device 24 includes two carrier supplying portions, that is, a first carrier supplying portion 44a and a second carrier supplying portion 44b, as the carrier supplying portion 44. The first carrier supplying portion 44a stores the first carriers 45a and supplies the first carriers 45a to the stirring portion 31 of the developer storage portion 30. The second carrier supplying portion 44b stores the second carriers 45b and supplies the second carriers 45b to the stirring portion 31 of the developer storage portion 30. The first carriers 45a are carriers similar to the carriers 45 described above. The second carriers 45b have a lower chargeability than the first carriers 45a.

The developing device 24 illustrated in FIG. 11 is configured to be able to selectively supply the first carrier 45a having a high charging property and the second carriers 45b having a low charging property to the developer storage portion 30. Note that the other points are the same as the configuration illustrated in FIG. 2.

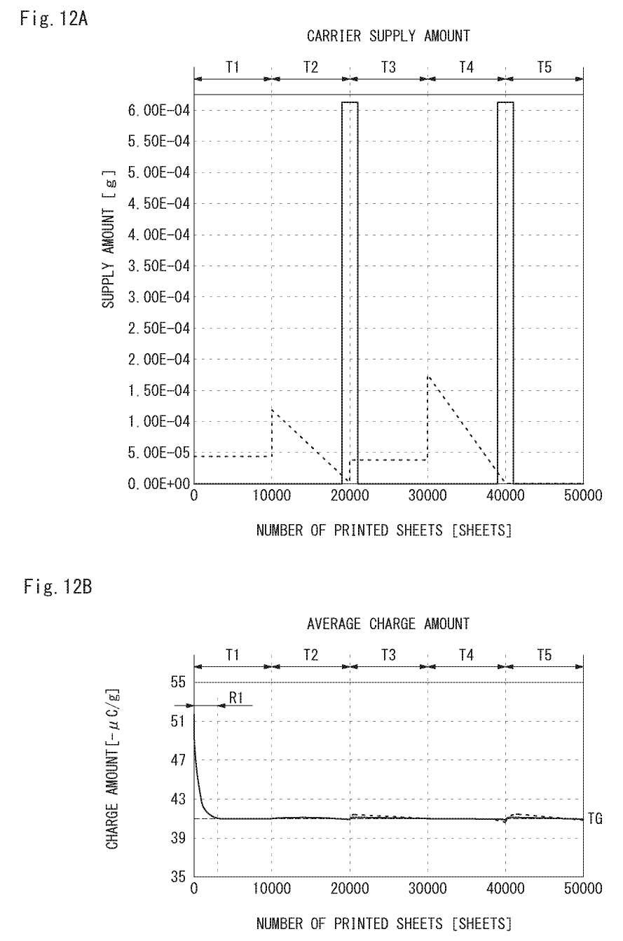

When determining the amount of carriers to be supplied in each section, controller 6 determines to supply second carriers 45b at the time of transition from a section with a low print coverage to a section with a high print coverage. FIG. 12A is a diagram showing the amount of supplied carriers determined in the developing device 24 of FIG. 11. In FIG. 12A, the solid line indicates the carrier supply amount of the second carriers 45b, and the broken line indicates the carrier supply amount of the first carriers 45a. The carrier supply amount of the first carriers 45a is similar to the supply amount indicated by the solid line in FIG. 9A.

The controller 6 determines the supply amount of the first carriers 45a in a similar manner to that for FIG. 9A. Further, the controller 6 determines to supply the second carriers 45b when the average print coverage in the section subsequent to the previous section is larger than the average print coverage in the previous section. In the example of FIG. 12A, the controller 6 determines that the print coverage increases when transitioning from the section T2 to the section T3 and when transitioning from the section T4 to the section T5, and determines to replenish the second carriers 45b in these section transitions.

The controller 6 determines the supply start timing of the second carriers 45b to be a timing at which the number of remaining printed sheets reaches a predetermined number of sheets (for example, 250 sheets) in the section before the transition to the section in which the print coverage increases. Furthermore, the controller 6 determines the supply end timing of the second carriers 45b as a timing when the number of printed sheets after the shift to the section in which the print coverage increases reaches a predetermined number of sheets (e.g., 250 sheets). That is, the controller 6 determines to replenish the second carriers 45b in the predetermined period before and after the transition from the previous section having a low print coverage to the next section having a high print coverage. Further, the controller 6 determines to replenish a predetermined amount as the supply amount of the second carriers 45b. Note that the supply start timing and the supply amount of the second carriers 45b may be determined based on the difference between the average print coverages in the two sections.

FIG. 12B illustrates change in average charge amount of toner in a case where the controller 6 replenishes the first carriers 45a and the second carriers 45b based on the supply amounts of the carriers illustrated in FIG. 12A after execution of a job is started. Note that a solid line in FIG. 12B indicates a change in the amount of charge in a case where the first and second carriers 45a and 45b are replenished, and a broken line indicates a change in the amount of charge in FIG. 9B. In addition, the target charge amount TG similar to the above is illustrated in FIG. 12B.

As illustrated in FIG. 12B, the charge amount of toner rapidly decreases for a predetermined period R1 immediately after the start of execution of a job. However, as described above, the rapid decrease in the charge amount during the predetermined period R1 can be eliminated by starting the stirring operation in the developing device 24 prior to the start of the execution of the job.

When the section T2 having a low print coverage shifts to the section T3 having a high print coverage, the controller 6 supplies the second carriers 45b in a predetermined period before and after the shift. Furthermore, when the section T4 having a low print coverage shifts to the section T5 having a high print coverage, the controller 6 supplies the second carriers 45b in a predetermined period before and after the shift. The second carriers 45b are lower in chargeability than the first carriers 45a. For that reason, the second carrier 45b is supplied before shifting to the section in which the print coverage becomes high, so that the charging property of the entire carrier in the developer storage portion 30 lowers. As a result, as shown in FIG. 12B, it is possible to suppress a rapid increase in the charge amount immediately after the transition to the section T3 or T5 of the high print coverage. That is, the change in the amount of charge illustrated in FIG. 12B is suppressed more than the change in the amount of charge illustrated in FIG. 9B. Therefore, by supplying the first and second carriers 45a and 45b, the image forming apparatus 1 can form a higher quality image.

Note that the example in which two types of carriers, the first and second carriers 45a and 45b, are replenished has been described above. However, the type of the carrier to be supplied to the developer storage portion 30 is not limited to two types. For example, when three kinds of carriers are supplied, the charge amount can be more finely adjusted.

### MODIFICATION EXAMPLE

A preferred embodiment of the present invention has been described above. However, the present invention is not limited to the content described in the above embodiment, and various modification examples are applicable.

For example, in the above-described embodiment, except for Comparative Example 1, the example in which mainly only the toner 42 is supplied from the toner storage portion 41 to the developer storage portion 30 has been described. However, the present invention is not limited thereto, and the toner storage portion 41 may supply a two-component developer including toner and carrier to the developer storage portion 30.

In addition, the program executed by the hardware processor of the controller 6 described in the above-described embodiment can be a transaction target by itself. Therefore, the program may be a program that is installed in the controller 6 of the image forming apparatus 1 as necessary. In this case, the program is provided in a downloadable form via a network such as the Internet, for example. Further, the program is provided in a form recorded in a computer-readable recording medium such as a CD-ROM or a USB memory.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image forming apparatus, comprising:
a developer storage portion that stores two-component developer containing toner and carrier;
a supply portion supplying the two-component developer stored in the developer storage portion to a surface of an image bearing member;
a discharge portion to discharge a surplus of the two-component developer from the developer storage portion;
a carrier supply portion that replenishes the developer storage portion with carrier; and
a controller calculating a variation amount of print coverage in a series of jobs on the basis of job information on the series of jobs subject to image formation and determining a supply amount of carrier to be replenished from the carrier supply portion on the basis of the variation amount.

2. The image forming apparatus according to claim 1, wherein
the controller divides the series of jobs into a plurality of sections, and calculates an average print coverage in each section, the number of printed sheets in each section, and the variation amount of the average print coverage when transitioning to each section, thereby determining the supply amount of carrier in each section.

3. The image forming apparatus according to claim 2, wherein
when dividing the series of jobs into a plurality of sections, the controller divides the series of jobs such that the number of printed sheets in each section is equal to or greater than a predetermined number.

4. The image forming apparatus according to claim 2, wherein
when the average print coverage in a next section subsequent to a previous section is smaller than the average print coverage in the previous section, the controller increases the supply amount of carrier immediately after the transition to the next section to be larger than the supply amount of carrier in the previous section.

5. The image forming apparatus according to claim 4, wherein
the controller gradually decreases the supply amount of carrier as the number of printed sheets in the next section increases from immediately after transition to the next section.

6. The image forming apparatus according to claim 2, wherein
when the average print coverage in a next section subsequent to a previous section is larger than the average print coverage in the previous section, the controller holds the supply amount of carrier in the next section at a constant value corresponding to the average print coverage in the next section.

7. The image forming apparatus according to claim 2, wherein
the controller acquires an indicator value indicating a state of the two-component developer during execution of the series of jobs, and
the controller determines the supply amount of carrier before execution of the series of jobs is started, and corrects the supply amount of carrier based on the indicator value during the execution of the series of jobs.

8. The image forming apparatus according to claim 7, wherein
the indicator value includes at least one of a charge amount of toner, a transfer amount of toner, a bulk density of the two-component developer, and a driving load of the supply portion.

9. The image forming apparatus according to claim 2, wherein
the carrier supply portion is configured to supply first carrier and second carrier different in chargeability from the first carrier to the developer storage portion, and
when the average print coverage in a next section subsequent to a previous section is larger than the average print coverage in the previous section, the controller determines a supply amount of the first carrier in the next section based on the average print coverage in the next section, and determines to supply the second carrier in a predetermined period before and after a transition from the previous section to the next section.

10. A control method for an image forming apparatus, the image forming apparatus comprising:
a developer storage portion that stores two-component developer containing toner and carrier;
a supply portion supplying the two-component developer stored in the developer storage portion to a surface of an image bearing member;
a discharge portion to discharge a surplus of the two-component developer from the developer storage portion; and
a carrier supply portion that replenishes the developer storage portion with carrier, wherein
the control method comprises:
calculating a variation amount of print coverage in a series of jobs on the basis of job information on the series of jobs subject to image formation; and
determining a supply amount of carrier to be replenished from the carrier supply portion on the basis of the variation amount.

11. The control method according to claim 10, wherein
the control method divides the series of jobs into a plurality of sections, and calculates an average print coverage in each section, the number of printed sheets in each section, and the variation amount of the average print coverage when transitioning to each section, thereby determining the supply amount of carrier in each section.

12. The control method according to claim 11, wherein
when dividing the series of jobs into a plurality of sections, the control method divides the series of jobs such that the number of printed sheets in each section is equal to or greater than a predetermined number.

13. The control method according to claim 11, wherein
when the average print coverage in a next section subsequent to a previous section is smaller than the average print coverage in the previous section, the control method increases the supply amount of carrier immediately after the transition to the next section to be larger than the supply amount of carrier in the previous section.

14. The control method according to claim 13, wherein
the control method gradually decreases the supply amount of carrier as the number of printed sheets in the next section increases from immediately after transition to the next section.

15. The control method according to claim 11, wherein
when the average print coverage in a next section subsequent to a previous section is larger than the average print coverage in the previous section, the control method holds the supply amount of carrier in the next section at a constant value corresponding to the average print coverage in the next section.

16. The control method according to claim 11, further comprising:
acquiring an indicator value indicating a state of the two-component developer during execution of the series of jobs, wherein
the control method determines the supply amount of carrier before execution of the series of jobs is started, and corrects the supply amount of carrier based on the indicator value during the execution of the series of jobs.

17. The control method according to claim 16, wherein
the indicator value includes at least one of a charge amount of toner, a transfer amount of toner, a bulk density of the two-component developer, and a driving load of the supply portion.

18. The control method according to claim 11, wherein
the carrier supply portion is configured to supply first carrier and second carrier different in chargeability from the first carrier to the developer storage portion, and
when the average print coverage in a next section subsequent to a previous section is larger than the average print coverage in the previous section, the control method determines a supply amount of the first carrier in the next section based on the average print coverage in the next section, and determines to supply the second carrier in a predetermined period before and after a transition from the previous section to the next section.

19. A non-transitory computer-readable recording media storing a program to be executed by a hardware processor of an image forming apparatus, the image forming apparatus comprising:
a developer storage portion that stores two-component developer containing toner and carrier;
a supply portion supplying the two-component developer stored in the developer storage portion to a surface of an image bearing member;
a discharge portion to discharge a surplus of the two-component developer from the developer storage portion; and
a carrier supply portion that replenishes the developer storage portion with carrier, wherein
the program causes the hardware processor to perform:
calculating a variation amount of print coverage in a series of jobs on the basis of job information on the series of jobs subject to image formation; and
determining a supply amount of carrier to be replenished from the carrier supply portion on the basis of the variation amount.
